(19) United States
(12) Patent Application Publication
(10) Pub. No.: US 2024/0005329 A1
(43) Pub. Date: Jan. 4, 2024

(54) DETERMINATION APPARATUS, DETERMINATION METHOD AND PROGRAM

(71) Applicant: NIPPON TELEGRAPH AND TELEPHONE CORPORATION, Tokyo (JP)

(72) Inventors: Atsushi NAKADAIRA, Tokyo (JP); Shigeru FUJIMURA, Tokyo (JP); Shigenori OHASHI, Tokyo (JP); Keita SUZUKI, Tokyo (JP); Honoka TODA, Tokyo (JP)

(21) Appl. No.: 18/250,413

(22) PCT Filed: Nov. 10, 2020
(86) PCT No.: PCT/JP2020/041948

§ 371 Date: Apr. 25, 2023

(51) Int. Cl. G06Q 20/40

(52) U.S. Cl. CPC G06Q 20/4016

(57) ABSTRACT

A determination apparatus according to an embodiment includes: an input unit that inputs information indicating a first transaction action expected to be performed by a first user, information indicating a second transaction action expected to be performed by a second user, information regarding the first user, and information regarding the second user disclosed by the second user to the first user; an expected value calculation unit that calculates an expected value indicating reliability with which the second user performs the second transaction action when the first user performs the first transaction action by use of the information indicating the first transaction action, the information indicating the second transaction action, the information regarding the first user, and the information regarding the second user; and a feasibility determination unit that determines feasibility of a transaction contract represented by the first transaction action and the second transaction action by use of the expected value.

### TECHNICAL FIELD

The present invention relates to a determination apparatus, a determination method, and a program.

### BACKGROUND ART

It is assumed that transactions between individuals and small-to-medium-sized enterprises increase due to global connections between individuals. In addition, even for companies, it is assumed that transactions with companies in other countries far away increase. In order to implement such a transaction, it is necessary to be able to make a contract with mutual reliability in terms of fulfilment of the contract.

As a conventional technique, there is known a technique of calculating a credit status regarding payment of an individual or a company as a score and evaluating the score (for example, Non Patent Literature 1). Such a score (degree of credibility or degree of reliability) is used as an index for determining the feasibility of a transaction.

### CITATION LIST

### Non Patent Literature

Non Patent Literature 1: the Ministry of Internal Affairs and Communications, “the 2018 White Paper on Information and Communications in Japan”, Internet <URL:https://www.soumu.go.jp/johotsusintokei/whitepaper/ja/h30/pdf/n2700000.pdf>

### SUMMARY OF INVENTION

### Technical Problem

However, the degree of reliability is calculated for each individual or company by a certain certification organization or the like, and a calculation algorithm for the degree of reliability cannot be selected. In addition, it is necessary to provide personal information to the certification organization, and the personal information determines personal evaluation of an individual, for example.

In addition, it is desired to disclose personal information, financial conditions of a juridical person, and the like for calculating the degree of reliability, which are sensitive information, only to a party who really needs such information. Meanwhile, in a case where sensitive information cannot be used, there is a possibility that the accuracy of the degree of reliability is lowered.

An embodiment of the present invention has been made in view of the above points, and an object thereof is to determine the feasibility of a transaction by use of information disclosed from a transaction partner.

### Solution to Problem

In order to achieve the above object, a determination apparatus according to an embodiment includes: an input unit that inputs information indicating a first transaction action expected to be performed by a first user, information indicating a second transaction action expected to be performed by a second user, information regarding the first user, and information regarding the second user disclosed by the second user to the first user; an expected value calculation unit that calculates an expected value indicating reliability with which the second user performs the second transaction action when the first user performs the first transaction action by use of the information indicating the first transaction action, the information indicating the second transaction action, the information regarding the first user, and the information regarding the second user; and a feasibility determination unit that determines feasibility of a transaction contract represented by the first transaction action and the second transaction action by use of the expected value.

### Advantageous Effects of Invention

The feasibility of a transaction can be determined by use of information disclosed from a transaction partner.

### BRIEF DESCRIPTION OF DRAWINGS

FIG. 1 is a diagram illustrating an example of a hardware configuration of a determination device according to the present embodiment.

FIG. 2 is a diagram illustrating an example of a functional configuration of the determination device according to the present embodiment.

FIG. 3 is a flowchart illustrating an example of a flow of processing executed by the determination device according to the present embodiment.

### DESCRIPTION OF EMBODIMENTS

Hereinafter, an embodiment of the present invention will be described. In the present embodiment, assuming that a contract is made such that A and B, who are individuals or juridical persons, mutually perform a transaction action, a determination device 10 (determination apparatus) will be described that is capable of determining the feasibility of the transaction by use of information disclosed from a transaction partner. In addition, at this time, a case of calculating an expected value for determining the feasibility of the transaction, a case of making a notification when there is a difference in ability between A and B, and the like will also be described.

Here, the information disclosed from a transaction partner is information regarding the transaction partner (for example, attribute information or the like of the person), and is used to determine the feasibility of the transaction. The disclosed information may be information in which an action of the transaction partner is recorded such as an action log, or information including the information in which an action is recorded such as an action log.

In addition, the expected value does not necessarily mean a mathematical expected value, but indicates an index value such as a degree of reliability or a reliability score indicating how reliable one is for the other. That is, in a case where a transaction contract is made between A and B such that A performs an action x and B performs an action y, the expected value indicates, for example, a degree of reliability, a reliability score, or the like indicating a possibility that B performs the action y when A performs the action x. In other words, the expected value is a concept in which a degree of reliability or a reliability score is extended even for any transaction action other than a payment action.

Typically, in a case where the action x is payment of money and the action y is provision of a certain service or delivery of a certain product, the expected value is an index value indicating that the provision of the service or the delivery of the product is performed as expected when A pays money. Therefore, for example, even in a case where there is a high possibility that the quality of the service or the product is low (typically, in a case where there is a high possibility that the product is a defective product, for example), the expected value is low.

In addition, the transaction action is an action as a purpose of a transaction contract, and is, for example, an action of paying money, an action of delivering a product, an action of providing a service, or the like. The feasibility of the transaction indicates an index value indicating a possibility that the transaction is effectively established as expected by a contractor.

Note that, hereinafter, it is assumed that A and B make a transaction contract such that A performs the action x and B performs the action y, and the effectiveness of the transaction is determined. At this time, in the present embodiment, mainly, it is assumed that A is a user of the determination device 10, and determines the feasibility of the transaction by use of information disclosed from the transaction partner B. Therefore, hereinafter, A as a user of the determination device 10 is also referred to as a “transactor”, and B is also referred to as a “transaction partner” or simply the “partner”.

However, at the same time, A can also disclose information regarding A to B, and B can also determine the feasibility of the transaction by the determination device 10. That is, A and B can disclose their own information (in particular, information that is considered by A or B himself to be disclosable to the other party, or information that is requested by the other party and that is considered by A or B himself to be disclosable to the other party) to each other and mutually determine the feasibility of the transaction.

<Hardware Configuration>

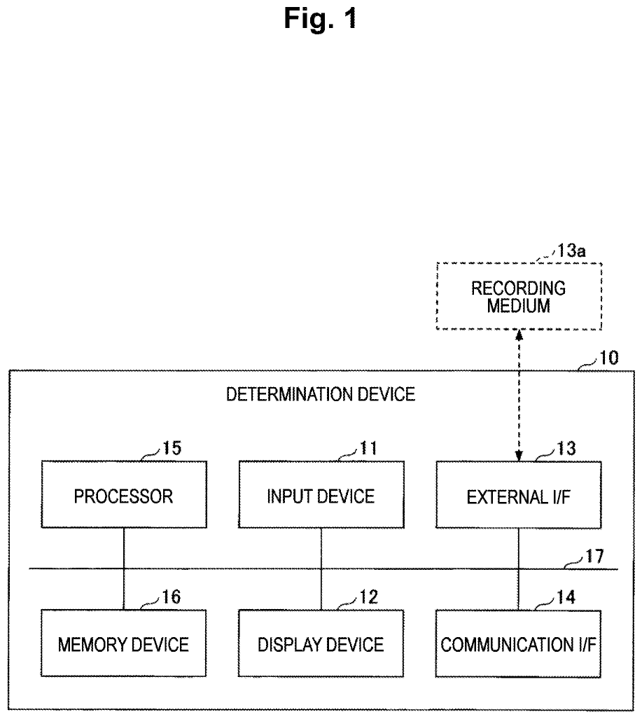

First, a hardware configuration of the determination device 10 according to the present embodiment will be described with reference to FIG. 1. FIG. 1 is a diagram illustrating an example of the hardware configuration of the determination device 10 according to the present embodiment.

As illustrated in FIG. 1, the determination device 10 according to the present embodiment is implemented by a hardware configuration of a general computer or computer system, and includes an input device 11, a display device 12, an external I/F 13, a communication I/F 14, a processor 15, and a memory device 16. These pieces of hardware are communicably connected via a bus 17.

The input device 11 is, for example, a keyboard, a mouse, a touch panel, or the like. The display device 12 is, for example, a display or the like. Note that the determination device 10 may not include, for example, at least one of the input device 11 and the display device 12.

The external I/F 13 is an interface with an external device such as a recording medium 13a. The determination device 10 can, for example, read from and write in the recording medium 13a via the external I/F 13. Note that examples of the recording medium 13a include a compact disc (CD), a digital versatile disk (DVD), a secure digital memory card (SD memory card), a universal serial bus (USB) memory card, and the like.

The communication I/F 14 is an interface for connecting the determination device 10 to a communication network. The processor 15 is, for example, an arithmetic device of various types such as a central processing unit (CPU) and a graphics processing unit (GPU). The memory device 16 is, for example, a storage device of various types such as a hard disk drive (HDD), a solid state drive (SSD), a random access memory (RAM), a read only memory (ROM), and a flash memory.

The determination device 10 according to the present embodiment has the hardware configuration illustrated in FIG. 1, and thus can implement various types of processing to be described later. Note that the hardware configuration illustrated in FIG. 1 is an example, and the determination device 10 may have another hardware configuration. For example, the determination device 10 may include a plurality of processors 15 or a plurality of memory devices 16.

<Functional Configuration>

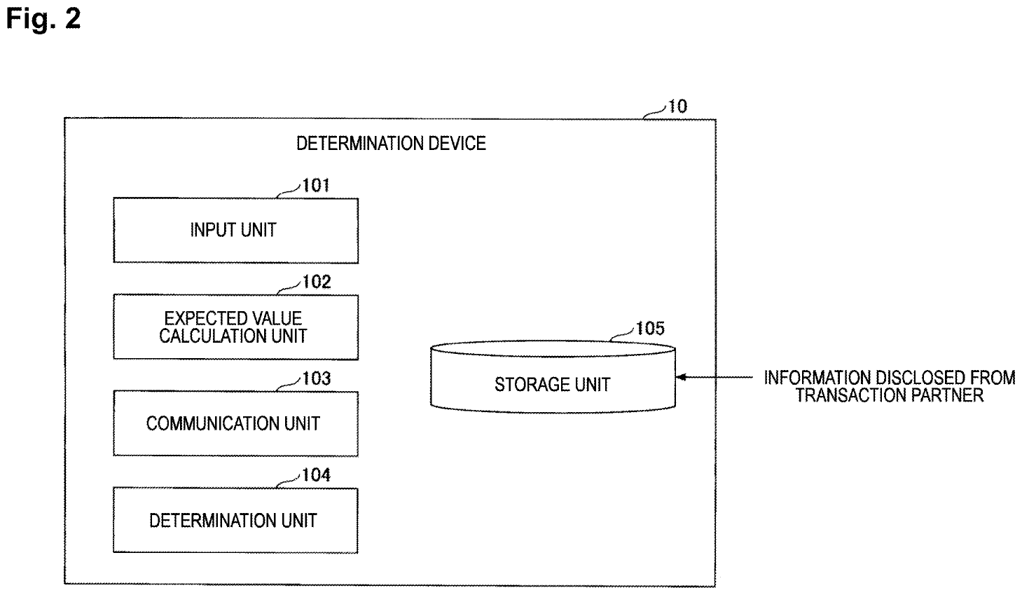

Next, a functional configuration of the determination device 10 according to the present embodiment will be described with reference to FIG. 2. FIG. 2 is a diagram illustrating an example of the functional configuration of the determination device 10 according to the present embodiment.

As illustrated in FIG. 2, the determination device 10 according to the present embodiment includes an input unit 101, an expected value calculation unit 102, a notification unit 103, and a determination unit 104. Each of these units is implemented by, for example, processing executed by the processor 15 by one or more programs installed in the determination device 10.

In addition, the determination device 10 according to the present embodiment includes a storage unit 105. The storage unit 105 is implemented by, for example, the memory device 16. Note that the storage unit 105 may be implemented by, for example, a storage device (database server or the like) connected to the determination device 10 via a communication network.

The storage unit 105 stores information regarding the transactor (hereinafter, also referred to as “transactor information”), information disclosed from the transaction partner (hereinafter, also referred to as “disclosed information”), and the like.

Here, the transactor information is information indicating various attributes of the transactor, and may include, for example, information indicating various attributes described below.
Ability of the transactor
Reliability of the transactor (honesty, cooperativity, altruism, and the like)
Social Intelligence of the transactor
Propensity of the transactor
Sense of values of the transactor

Note that each piece of information that can be included in the transactor information is an example, and information indicating various attributes can be included in addition to the above information.

In addition, the disclosed information is information disclosed by the transaction partner to the transactor among information indicating various attributes of the transaction partner. The disclosed information of the transaction partner may include, for example, information indicating attributes described below.
Ability of the transaction partner
Reliability of the transaction partner (honesty, cooperativity, altruism, and the like)
Social intelligence of the transaction partner
Propensity of the transaction partner
Sense of values of the transaction partner

Note that each piece of information that can be included in the disclosed information is an example, and information indicating various attributes can be included in addition to the above information.

Here, which attribute information the transaction partner discloses to the transactor is determined by the transaction partner himself. Therefore, all or a part of the information indicating the attributes is disclosed to the transactor. In addition, the transactor also discloses all or a part of the information indicating the attributes of the transactor to the transaction partner. That is, the transactor and the transaction partner each determine which information to disclose to the other party, and disclose the information. For this reason, the transactor and the transaction partner can determine by themselves how much personal information such as attribute information is disclosed to the other party in the transaction contract.

Note that, in addition to the transactor information and the disclosed information described above, for example, relationship information indicating a relationship (including not only a direct relationship but also an indirect relationship via a third party) between the transactor and the transaction partner may be stored in the storage unit 105. In addition, all or a part of the relationship information may be information disclosed from the transaction partner.

The relationship information is information indicating a personal or social relationship between the transactor and the transaction partner, and may include, for example, information indicating various relationships listed below.
Presence or absence of a debt of gratitude between the transactor and the transaction partner and a degree thereof
Presence or absence of a blood relationship between the transactor and the transaction partner and a degree thereof
Social standing or professional reliability of the transactor and the transaction partner
A social relationship between the transactor and the transaction partner (for example, a relationship between a doctor and a patient, a relationship between a teacher and a student, a relationship between a boss and a subordinate, or the like)
A degree to which the transactor evaluates the ability of the transaction partner (alternatively, a degree to which the transaction partner evaluates the ability of the transactor)

Note that each piece of information that can be included in the relationship information is an example, and information indicating various relationships can be included in addition to the above information.

The input unit 101 inputs information indicating the action x of the transactor, information indicating the action y of the transaction partner, the transactor information, and the disclosed information. Note that the input unit 101 may further input the relationship information.

Note that the information indicating the action x and the information indicating the action y may be input from, for example, the input device 11 or the like, or may be input by being read from the storage unit 105. Meanwhile, the transactor information and the disclosed information are input by being read from the storage unit 105.

The expected value calculation unit 102 calculates an expected value f_{A,x}(B, y) at which the transaction partner performs the action y when the transactor performs the action x by using the information indicating the action x of the transactor, the information indicating the action y of the transaction partner, the transactor information, and the disclosed information. The expected value calculation unit 102 calculates the expected value f_{A,x}(B, y) by any expected value calculation algorithm selected by the transactor. Note that the expected value calculation unit 102 may calculate the expected value f_{A,x}(B, y) by further using the relationship information.

In a case where a predetermined notification condition is satisfied, the notification unit 103 outputs a notification indicating that the notification condition is satisfied to the transactor. Here, examples of the notification condition include a case where a difference between the ability of the transactor and the ability of the transaction partner is equal to or larger than a predetermined difference. This is, for example, to prevent one from performing some sort of deception or fraudulent action on the other in a case where a difference in ability in the field covered by the contract is equal to or larger than a predetermined difference (that is, in a case where there is an ability gap).

Note that specific examples of the ability include an ability of a translation target language in a contract for commissioning/undertaking translation work of a software manual. In this case, for example, in a case where the ability of the transactor is extremely lower than the ability of the transaction partner, the transactor cannot check a product (translated software manual), and thus has a risk of being deceived or defrauded, for example. Other specific examples of the ability include an ability to pay money.

The determination unit 104 uses the expected value y) to determine the feasibility of the transaction between the transactor and the transaction partner.

<Flow of Processing>

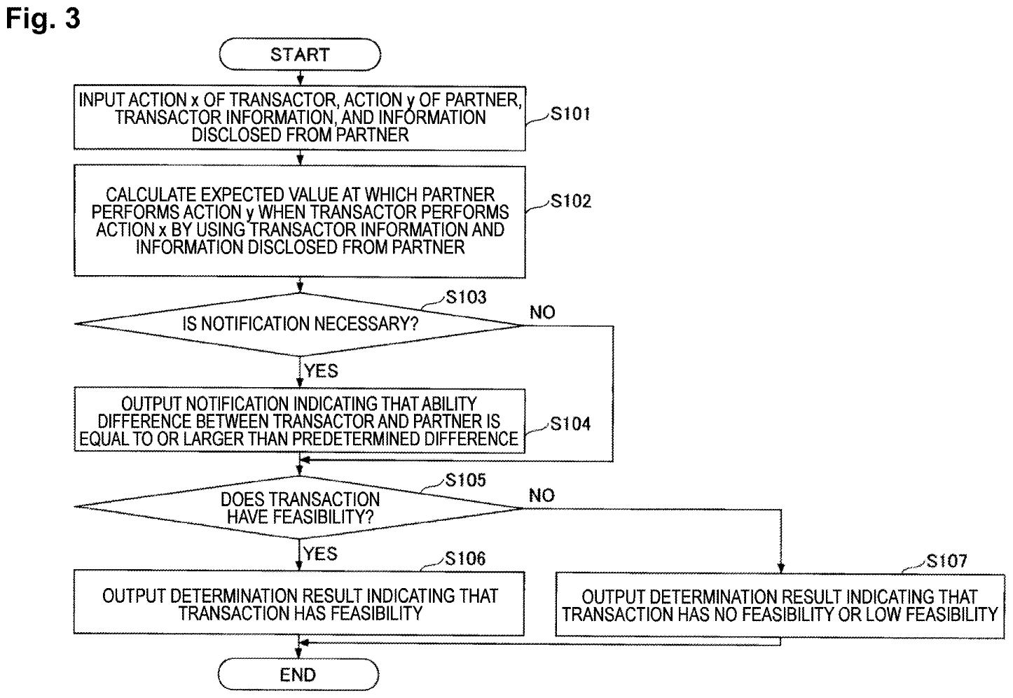

Next, a flow of processing executed by the determination device 10 according to the present embodiment will be described with reference to FIG. 3. FIG. 3 is a flowchart illustrating an example of the flow of the processing executed by the determination device 10 according to the present embodiment.

First, the input unit 101 inputs information indicating the action x of the transactor, information indicating the action y of the transaction partner, transactor information, and disclosed information (step S101).

Next, the expected value calculation unit 102 calculates the expected value f_{A,x}(B, y) by any expected value calculation algorithm selected in advance by the transactor by using the information indicating the action x of the transactor, the information indicating the action y of the transaction partner, the transactor information, and the disclosed information (step S102). Note that the transactor may calculate a desired expected value calculation algorithm from among various known expected value calculation algorithms. In the expected value calculation algorithms selectable by the transactor, information that is emphasized to calculate the expected value, a type of a transaction contract for which the expected value can be calculated with high accuracy, and the like are different depending on the type of the expected value calculation algorithms.

Note that the expected value calculation unit 102 may verify the correctness (credibility) of the disclosed information input in step S101 described above before calculating the expected value f_{A,x}(B, y), and calculate the expected value only in a case where the verification result indicates that the credibility is recognized to be equal to or higher than a certain level. This is because the disclosed information is information disclosed from the transaction partner, and thus its correctness (credibility) may be low. For example, the transaction partner intentionally discloses wrong information to the transactor in order to establish the transaction. Therefore, the expected value calculation unit 102 may verify the correctness of the disclosed information input in step S101 by any method. Examples of the verification method include confirming consistency with information disclosed from the transaction partner in the past, confirming consistency with information possessed by an external reliable organization (including an individual or a juridical person), and the like. Furthermore, the expected value calculation unit 102 can select a calculation method considered to be appropriate by the transactor. For this reason, it is considered that the transactor himself can grasp the accuracy of the expected value calculation by verifying the correctness of the information and selecting the calculation method.

Next, the notification unit 103 determines whether or not a predetermined notification condition is satisfied (step S103). As described above, examples of the notification condition include a case where a difference between the ability of the transactor and the ability of the transaction partner is equal to or larger than a predetermined difference. Specifically, for example, in a case where the transactor commissions the transaction partner to perform a certain type of work (for example, translation work or the like of a software manual) as the action y, it is conceivable to set a notification condition that a difference between the ability of the transactor regarding the action y and the ability of the transaction partner regarding the action y is equal to or larger than a predetermined difference (that is, the ability of the transactor regarding the action y is lower than the ability of the transaction partner regarding the action y by a predetermined level or more).

In a case where it is determined in step S103 described above that the notification condition is satisfied, the notification unit 103 outputs a notification indicating that the notification condition is satisfied (step S104). For example, the notification unit 103 notifies the transactor that the difference between the ability of the transactor and the ability of the transaction partner is equal to or larger than the predetermined difference.

Note that, at this time, the notification unit 103 may notify the transaction partner of information for filling the difference between the ability of the transactor and the ability of the transaction partner. For example, in a case where the ability of the transactor is lower than the ability of the transaction partner by the predetermined level or more, the notification unit 103 may notify the transaction partner of information for filling the ability difference (that is, a difference in specialized knowledge, experience, or the like). Such information may be, for example, information regarding specialized knowledge or experience for filling the ability difference, information for introducing a reliable third party in the field, or the like.

In a case where it is not determined in step S103 described above that the notification condition is satisfied, or following step S104, the determination unit 104 uses the expected value f_{A,x}(B, y) to determine whether or not the transaction between the transactor and the transaction partner has feasibility (step S105). For example, the determination unit 104 compares the expected value f_{A,x}(B, y) with a predetermined threshold value, determines that the transaction has feasibility in a case where the expected value f_{A,x}(B, y) is larger than the threshold value, and determines that the transaction has no feasibility (or low feasibility) in a case where the expected value f_{A,x}(B, y) is not larger than the threshold value.

In a case where it is determined in step S105 described above that the transaction has feasibility, the determination unit 104 outputs a determination result indicating that the transaction between the transactor and the transaction partner has feasibility to the transactor (step S106). On the other hand, in a case where it is not determined in step S105 described above that the transaction has feasibility, the determination unit 104 outputs a determination result indicating that the transaction between the transactor and the transaction partner has no feasibility (or low feasibility) to the transactor (step S107). As a result, the transactor can know whether or not the transaction with the transaction partner has feasibility.

### SUMMARY

As described above, the determination device 10 according to the present embodiment calculates the expected value f_{A,x}(B, y) at which the transaction partner performs the action y when the transactor performs the action x by any algorithm using at least the transactor information and the disclosed information. At this time, in the determination device 10 according to the present embodiment, any information disclosed from the transaction partner can be used as the disclosed information, and any algorithm capable of calculating the expected value from the disclosed information (and the transactor information) can be used as the algorithm. Moreover, this algorithm can be arbitrarily selected by the transactor.

Therefore, according to the determination device 10 of the present embodiment, it is possible to calculate the expected value by any algorithm selected by the transactor by use of the transactor information and information that is considered by the transaction partner himself to be disclosable, and determine the feasibility of the transaction from the expected value. Therefore, for example, the transactor can use the feasibility determined by the determination device 10 as a material for determination in making a contract, or as a material for obtaining conviction after the contract.

Note that, in a case where the transaction partner uses a similar determination device 10, the transactor discloses information that is considered by the transactor himself to be disclosable as disclosed information to the transaction partner, and the transaction partner can similarly calculate an expected value with the determination device 10 and determine the feasibility of the transaction.

The present invention is not limited to the above-described specifically disclosed embodiment, and various modifications and changes, combinations with known techniques, and the like can be made without departing from the scope of the claims.

### REFERENCE SIGNS LIST

10 Determination device
11 Input device
12 Display device
13 External I/F
13a Recording medium
14 Communication I/F
15 Processor
16 Memory device
17 Bus
101 Input unit
102 Expected value calculation unit
103 Notification unit
104 Determination unit
105 Storage unit

1. A determination apparatus comprising:
a processor; and
a memory that includes instructions, which when executed, cause the processor to execute:
inputting information indicating a first transaction action expected to be performed by a first user, information indicating a second transaction action expected to be performed by a second user, information regarding the first user, and information regarding the second user disclosed by the second user to the first user;
calculating an expected value indicating reliability with which the second user performs the second transaction action when the first user performs the first transaction action by use of the information indicating the first transaction action, the information indicating the second transaction action, the information regarding the first user, and the information regarding the second user; and
determining feasibility of a transaction contract represented by the first transaction action and the second transaction action by use of the expected value.

2. The determination apparatus according to claim 1, wherein
the calculating includes
calculating the expected value by an expected value calculation algorithm selected by the first user.

3. The determination apparatus according to claim 1, wherein
the calculating includes
calculating the expected value in a case where credibility of the information regarding the second user is verified and a result of the verification indicates that the credibility is equal to or higher than a predetermined level.

4. The determination apparatus according to claim 1, further comprising:
determining whether or not an ability difference between the first user and the second user has a value equal to or higher than a predetermined value by use of information indicating an ability of the first user included in the information regarding the first user and information indicating an ability of the second user included in the information regarding the second user; and
outputting a predetermined notification to the first user in a case where it is determined that the ability difference has a value equal to or higher than the predetermined value.

5. The determination apparatus according to claim 4, wherein
the outputting includes
making a notification of information for filling the ability difference.

6. A determination method executed by a computer, the determination method comprising:
inputting information indicating a first transaction action expected to be performed by a first user, information indicating a second transaction action expected to be performed by a second user, information regarding the first user, and information regarding the second user disclosed by the second user to the first user;
calculating an expected value indicating reliability with which the second user performs the second transaction action when the first user performs the first transaction action by use of the information indicating the first transaction action, the information indicating the second transaction action, the information regarding the first user, and the information regarding the second user; and
determining feasibility of a transaction contract represented by the first transaction action and the second transaction action by use of the expected value.

7. A non-transitory computer-readable recording medium storing a program that causes a computer to function as the determination apparatus claim 1.
